(19) United States
(12) Patent Application Publication
(10) Pub. No.: US 2005/0141410 A1
(43) Pub. Date: Jun. 30, 2005

(54) Method of reducing peak-to-average ratio in multi-carrier communications systems

(75) Inventors: Yunjun Zhang, Ottawa (CA); Ping-Ya Zhao, Kanata (CA)

Correspondence Address: MARKS & CLERK, P.O. BOX 957, STATION B, OTTAWA, ON, K1P 5S7, CA

(73) Assignee: 1021 Technologies Inc., Kanata (CA)

(21) Appl. No.: 10/976,072

(22) Filed: Oct. 29, 2004

Related U.S. Application Data
(60) Provisional application No. 60/481,586, filed on Oct. 30, 2003.

(51) Int. Cl. H04J 11/00

(52) U.S. Cl. 370/206; 370/210; 375/261; 375/298

(57) ABSTRACT

A method of reducing peak-to-average ratio in multi-carrier communications systems, involves extracting sign bits from a data stream for each sub-carrier; scrambling the sign bits; recombining the scrambled sign bits with a remaining portion of the incoming data stream to form a transmission data stream; modulating the transmission data stream; transmitting the modulated transmission data stream over a transmission medium; receiving the modulated transmission data stream; extracting the scrambled sign bits from the received transmission data stream; unscrambling the scrambled sign bits; recombining the scrambled sign bits with a remaining portion of the received transmission data stream to form a received data stream; and demodulating the received data stream.

### CROSS REFERENCE TO RELATED APPLICATION

This invention claims the benefit of prior U.S. provisional application No. 60/481,586, filed Oct. 30, 2003, the contents of which are herein incorporated by reference.

### BACKGROUND OF INVENTION

The present invention relates to the field of digital communications, and in particular to a method of reducing peak-to-average power ratio (PAR) in a variety of orthogonal and non-orthogonal multi-carrier communications systems.

Typical orthogonal multi-carrier communications systems include Discrete Multitone (DMT) based Very-high-bit-rate Digital Subscriber Line (VDSL), Asymmetric Digital Subscriber Line (ADSL) family of transceivers, and any other systems employing Orthogonal Frequency Division Multiplexing (OFDM) technique.

Multi-carrier digital modulation schemes, especially those in orthogonal form (such as DMT and OFDM), are well known to be particularly efficient for high data rate applications, and therefore have been very popular with many of the newly emerging broadband twist-pair, power line and wireless applications. OFDM schemes distribute the data over a large number of sub-carriers that are spaced apart at precise frequencies. This spacing provides the “orthogonality” in this technique which prevents the demodulators from responding to frequencies other than their own. Detailed information on OFDM schemes can be obtained from the OFDM forum at 2891 Sunridge Way N.E, Calgary, Alberta TlY 7K7, www.ofdm-forum.com.

Both DMT and OFDM systems use Inverse Fast Fourier Transform (IFFT) as the modulation scheme and Fast Fourier Transform (FFT) as demodulation scheme. DMT and OFDM are distinguished by the fact that DMT is mainly used in base band and a bit-loading mechanism is applied to each sub-channel (i.e. sub-carrier) according to its signal-to-noise ratio (SNR).

DMT and OFDM are known to suffer from a number of drawbacks stemming mainly from their multi-carrier nature. Among the most notable drawbacks is the high Peak-to-Average Power Ratio (PAR) of the DMT and OFDM waveform. A high PAR factor has a direct impact on the increased complexity of the analog-to-digital and digital-to-analog converters in the modem circuitry, and on the efficiency of the power amplifier which needs the working point to be backed off substantially in order to avoid signal distortions and out-of-band emissions. Therefore, techniques that aim at mitigating this large PAR factor have become necessary in any practical implementation of DMT and OFDM based multi-carrier communication systems, which includes xDSL, wireless LAN (local area networks), wireless MAN (metropolitan- area networks) and DVB/DAB (digital video broadcasting/digital audio broadcasting) systems.

Various proposals for reducing PAR have been made in the prior art. Typical examples of prior art systems are found in U.S. Pat. Nos. 6,597,746; 6,512,797; 6,424,681; 6,314,146; 6,240,141; and 6,130,918, the contents of which are herein incorporated by reference.

### SUMMARY OF INVENTION

The transmitted waveform of multi-carrier modems is essentially the summation of a given number of sinuous tones with different phases and amplitudes determined by the symbols to be loaded to all the used sub-carriers (i.e. tones-with different frequencies). The bit-mapping scheme typically uses Quadrature Amplitude Modulation (QAM), although it should be noted that the bit mapping scheme used is not limited to QAM. Other schemes, such as PSK can also be applied.

Due to this summation nature of multi-carrier modulation, a high PAR of transmitted waveform is more likely to appear if the QAM symbols assigned to those sub-carriers carrying data are not uniformly distributed in the four quadrants of the QAM constellation. In other words, if more QAM symbols formed through the bit-mapping procedure are located in one quadrant of the QAM constellation than the other three quadrants, the resulting waveform more likely has a high PAR due to the fact those tones carrying QAM symbols having close phase values, which nearly results in an in-phase summation of those tones, thus more likely generate a higher peak.

Scrambling is normally applied to the data stream containing all the bits at the transmitter side to make the transmitted bit stream random like, as a subset of the scrambled bit stream, the sign bits which determine which quadrant each QAM symbol to be located may not be random enough. As a result, the generated QAM symbols may not be uniformly distributed in the four quadrants of the QAM constellation.

In accordance with the principles of the invention a scrambler dedicated to the sign bits on top of the scrambler is applied to the whole bit stream in each multi-carrier symbol. This further randomises the sign bit stream.

According to the present invention there is provided a method of reducing peak-to-average ratio in multi-carrier communications systems, comprising extracting sign bits from a data stream for each sub-carrier; scrambling said sign bits; recombining said scrambled sign bits with a remaining portion of said incoming data stream to form a transmission data stream; modulating said transmission data stream; transmitting said modulated transmission data stream over a transmission medium; receiving said modulated transmission data stream; extracting said scrambled sign bits from said received transmission data stream; unscrambling said scrambled sign bits; recombining said scrambled sign bits with a remaining portion of said received transmission data stream to form a received data stream; and demodulating said received data stream.

In another aspect the invention provides a transmission apparatus for use in multi-carrier communications systems, comprising: a sign bit extractor for extracting sign bits from a data stream for a sub-carrier; a sign bit scrambler for scrambling the extracted sign bits; a multiplexer for combining the scrambled sign bits with the remaining portion of the data stream to form a transmission stream; and a transmission module for transmitting said transmission stream over a transmission medium.

### BRIEF DESCRIPTION OF DRAWINGS

The invention will now be described in more detail, by way of example only, with reference to the accompanying drawings, in which:

FIG. 1 is a schematic illustration showing how sign bit stream is extracted from the bit stream of each multicarrier symbol (such as each DMT or OFDM symbol), then formed a sign bit stream and pass through a scrambler to randomize the sign bit stream.

FIG. 2 is a schematic illustration showing how original sign bits are recovered at the receiver side.

FIG. 3 is a schematic block diagram of a PAR control system with sign bit scrambling at the transmitter side.

FIG. 4 is schematic illustration showing the block diagram of the PAR control with sign bit scrambling at receiver side.

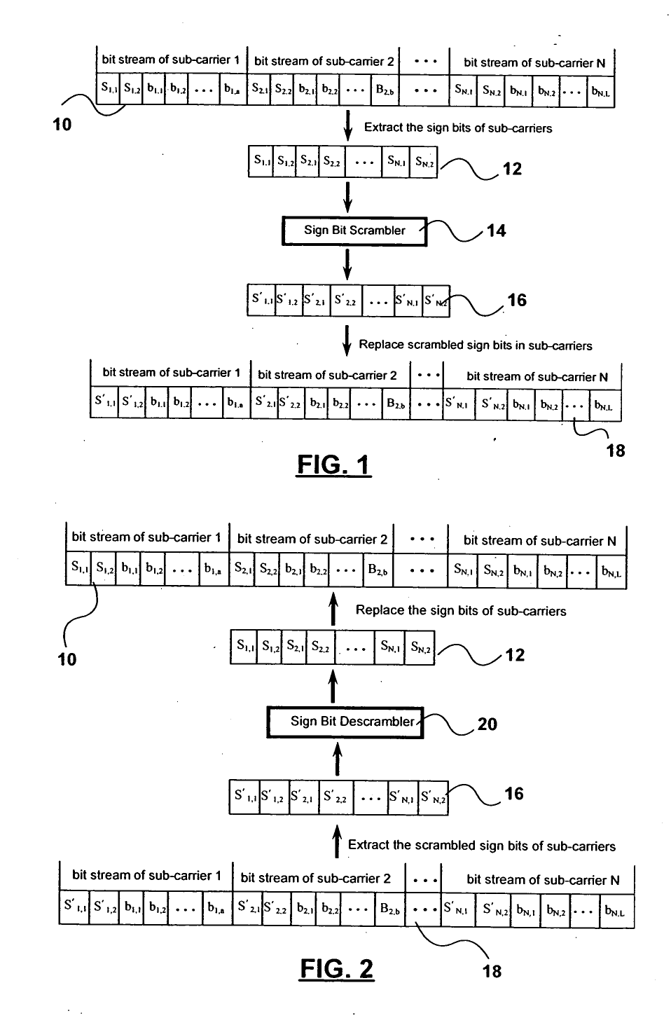

### DETAILED DESCRIPTION OF THE PREFERRED EMBODIMENTS

Further features and advantages of the present invention are becoming apparent from the following detailed description, taken in combination with the appended drawings, where S_{i,j} stands for an original sign bit and S′_{i,j} stands for the corresponding scrambled sign bit.

The invention can be implemented in a DMT modem. A typical DMT modem is described in U.S. Pat. No. 6,055,268, the contents of which are herein incorporated by reference.

Transmitter Sign Bit Scrambling

At transmit side, the sign bits 12 of the data bit stream 10 of each sub-carrier are extracted and fed into a scrambler 14. The scrambler 14 can be any scrambler used to produce a pseudorandom sequence for any given input-bit sequence. The initial state of the scrambler (i.e. the initial shift register contents) can be optimized according to the bit-loading profile (the number of bits on each sub-carrier for all the used sub-carriers). The predetermined initial state of the scrambler is also stored at receiver side for de-scrambling purpose.

The original sign bits 12 of each sub-carrier are then replaced by the scrambled sign bits 16 and the resulting whole bit stream 18 replaced the original bit stream 10 and is fed into the constellation encoder to produce the symbols (such as QAM symbols) to be carried by each used sub-carrier. The outputs of the constellation encoder are then fed into the modulation engine at the transmitter for transmission over a transmission medium.

Receiver Sign Bit De-Scrambling

At the receiver side the reverse process is employed to recover the original sign bits of each used sub-carrier, which are also part of data bit stream. A de-scrambler 20 is applied right after the constellation decoder. As shown in FIG. 2, scrambled sign bits 16 of each multicarrier symbol are extracted from the received bit stream 18 to form a scrambled sign bit stream. These are then passed to the descrambler 20, which has the same initial state as the scrambler 14 at the transmit side and is then able to unscramble the sign bits. The descrambler extracts the original sign bits 12. These are then put back into the data stream to recreate the original bit stream 10, which is then passed to the next processing block in a conventional manner.

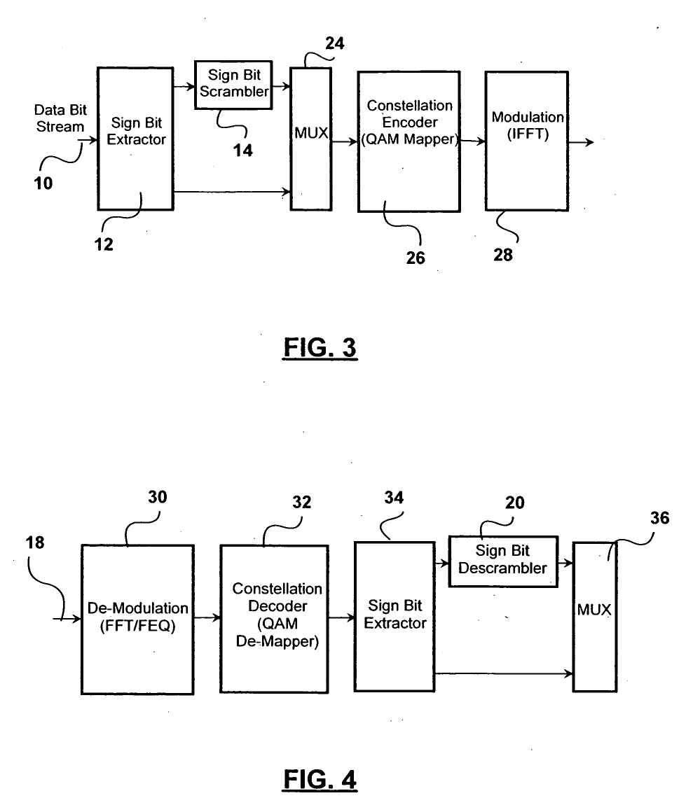

FIG. 3 is a block diagram of the sign bit scrambling block at the transmitter side. The sign bit scrambling is performed immediately before bit mapping (with a QAM mapper or constellation encoder in general). The incoming data stream 10 is fed into the sign bit extractor 22, which feeds the bits into the sign bit scrambler 14. The output of the sign b it scrambler 14 is fed to one input of multiplexer 24 whose other input receives the data bits bₙ from the sign bit extractor 22.

The multiplexer 24 feeds the scrambled bit stream to a QAM mapper 26, which feeds the symbols to modulation engine 28, which in the in case of DMT or OFDM is an IFFT engine.

FIG. 4 is a block diagram of the descrambling block on the receive side. The sign bit descrambling is performed right after bit de-mapping (i.e. after the QAM de-Mapper or constellation decoder in general). The incoming bit stream 18 is fed in turn to a demodulator 30, and QAM demapper 32. The output of the QAM demapper is passed to sign bit extractor 34, which passes the sign bits to sign bit descrambler 30 and the remaining data bits to multiplexer 36, where the two bit streams are recombined to recreate the original data stream 10.

By applying a simple scrambling process to the sign bits of all used sub-carriers, the invention can eliminate scenarios where the symbols (such as QAM symbols) carried by the used sub-carriers are not uniformly distributed in the four quadrants of the constellation. Thus it avoids those bit-loading profiles which generate high PARs.

This PAR control scheme can be easily used jointly with other PAR control techniques to guarantee the efficiency of the power amplifier and the quality of the transmitted signal in multicarrier communication systems.

1. A method of reducing peak-to-average ratio in multi-carrier communications systems, comprising:
extracting sign bits from a data stream for each sub-carrier;
scrambling said sign bits;
recombining said scrambled sign bits with a remaining portion of said incoming data stream to form a transmission data stream;
modulating said transmission data stream;
transmitting said modulated transmission data stream over a transmission medium;
receiving said modulated transmission data stream;
extracting said scrambled sign bits from said received transmission data stream;
unscrambling said scrambled sign bits;
recombining said scrambled sign bits with a remaining portion of said received transmission data stream to form a received data stream; and
demodulating said received data stream.

2. The method of claim 1, comprising scrambling said sign bits into a pseudorandom sequence.

3. The method of claim 2, comprising encoding said transmission data stream with a QAM mapper prior to modulation.

4. The method of claim 3, comprising modulating said transmission data stream with an IFFT modulation engine.

5. The method of claim 4, comprising demodulating said received data stream with an FFT demodulation engine

6. The method of claim 5, comprising demodulating said received data stream is decoded with a QAM de-mapper.

7. A method of transmitting signals with reduced peak-to-average ratio in multi-carrier communications systems, comprising:
extracting sign bits from a data stream for each sub-carrier;
scrambling said sign bits;
recombining said scrambled sign bits with a remaining portion of said incoming data stream to form a transmission data stream;
modulating said transmission data stream;
and transmitting said modulated transmission data stream over a transmission medium.

8. The method of claim 6, wherein comprising scrambling said sign bits into a pseudorandom sequence.

9. The method of claim 8, comprising encoding said transmission data stream with a QAM mapper prior to modulation.

10. The method of claim 9, comprising modulating said transmission data stream with an IFFT modulation engine.

11. A transmission apparatus for use in multi-carrier communications systems, comprising:
a sign bit extractor for extracting sign bits from a data stream for a sub-carrier;
a sign bit scrambler for scrambling the extracted sign bits;
a multiplexer for combining the scrambled sign bits with the remaining portion of the data stream to form a transmission stream; and
and a transmitter for transmitting said transmission stream over a transmission medium.

12. The transmission apparatus of claim 11, wherein said sign bit scrambler is a pseudorandom scrambler.

13. The transmission apparatus of claim 12, wherein said transmitter comprises a QAM mapper and IFFT modulator.

14. A receiver apparatus for use in multi-carrier communications systems, comprising:
a sign bit extractor for extracting scrambled sign bits from an incoming data stream for each sub-carrier;
a descrambler for descrambling said scrambled sign bits; and
a multiplexer for combining said scrambled sign bits into an output bit stream.

15. The receiver apparatus of claim 14, wherein said descramnbler is a pseudorandom descrambler having a predetermined initial state so as to descramble said sign bits.

16. The receiver apparatus of claim 15, further comprising a front-end receiver module for receiving an incoming signal, said receiver module including an FFT demodulator.

17. The receiver apparatus of claim 116, wherein said receiver module includes a QAM de-mapper.
